(19) United States
(12) Patent Application Publication
(10) Pub. No.: US 2013/0244096 A1
(43) Pub. Date: Sep. 19, 2013

(54) LITHIUM SECONDARY BATTERY

(71) Applicants: Sumihito ISHIDA, Yongin-si (JP); Jungwoo An, Yongin-si (KR); Euihwan Song, Yongin-si (KR)

(72) Inventors: Sumihito ISHIDA, Yongin-si (JP); Jungwoo An, Yongin-si (KR); Euihwan Song, Yongin-si (KR)

(73) Assignee: Samsung SDI Co., Ltd., Yongin-si (KR)

(21) Appl. No.: 13/595,919

(22) Filed: Aug. 27, 2012

(30) Foreign Application Priority Data
Mar. 13, 2012 (KR) 10-2012-0025757

(51) Int. Cl. H01M 4/58

(52) U.S. Cl. 429/188

(57) ABSTRACT

Provided is a lithium secondary battery having high stability and high energy density. A lithium secondary battery includes a positive electrode and a negative electrode wherein the positive electrode includes one or more positive electrode active materials selected from LiFeₓM_{y}PO₄, Li₂FeₓM_{y}P₂O₇, Li₃FeₓM_{y}(PO₄)₃, and LiFeₓM_{y}O₂, and coated on at least one surface of a current collector, where M is at least one selected from cobalt (Co), nickel (Ni), manganese (Mn), (Al), (Sn), and (Sb), 0<x≦1, and 0≦y≦1, the negative electrode includes one or more negative electrode active materials selected from Li₄(TiₚN_{q})₅O₁₂ and Li₂(TiₚN_{q})₃O₇, and coated on at least one surface of a current collector, where N is at least one selected from Co, Ni, Mn, Al, Sn, and Sb, 0<p≦1, and 0≦q<1, and the electrolyte includes a lithium (Li) ion-containing aqueous solution.

### CROSS-REFERENCE TO RELATED APPLICATIONS

This application claims the benefit of Korean Patent Application No. 10-2012-0025757, filed on Mar. 13, 2012, in the Korean Intellectual Property Office, the disclosure of which is incorporated herein in its entirety by reference.

### BACKGROUND

1. Field

The present embodiments relate to a lithium secondary battery.

2. Description of the Related Technology

Lithium secondary batteries use lithium metal oxides capable of intercalating or deintercalating lithium ions as positive electrode active materials and use lithium metal, a lithium alloy, (crystalline or amorphous) carbon or a carbon composite as negative electrode active materials. A positive electrode plate or negative electrode plate is formed by coating current collectors with the active materials in an appropriate thickness or length, or by coating the active materials itself in a film shape. An insulating separator is disposed between the positive electrode plate and the negative electrode plate, and is rolled together or stacked to form an electrode collector. The electrode collector is put in a can or a container similar thereto, and a lithium secondary battery is then prepared by injecting an electrolyte, in which a lithium salt is dissolved in an organic solvent.

An average discharge voltage of the lithium secondary battery is from about 3.6 V to 3.7 V and an electric power higher than those of other alkaline batteries, Ni-MH batteries, or Ni—Cd batteries may be obtained. However, an electrolyte, which is electrochemically stable in a charge and discharge voltage of 0 V to 4.2 V, is required in order to obtain the foregoing high driving voltage. For this reason, a non-aqueous electrolyte has been used, in which a lithium salt, such as LiPF₆, LiBF₄, and LiClO₄, is added as a lithium ion source to a non-aqueous carbonate-based solvent, such as ethylene carbonate, dimethyl carbonate, and diethyl carbonate. However, the non-aqueous electrolyte has significantly lower ionic conductivity than that of an aqueous electrolyte used in a Ni-MH battery or Ni—Cd battery, and thus, battery characteristics may deteriorate during high-rate charge and discharge.

### SUMMARY

An aspect of the present embodiments provides a lithium secondary battery having high stability and high energy density at an average voltage of 2 V.

According to at least one embodiment, a lithium secondary battery includes a positive electrode, a negative electrode, a separator disposed between the positive electrode and the negative electrode, and an electrolyte, wherein the positive electrode includes one or more positive electrode active materials selected from the group consisting of LiFeₓM_{y}PO₄, Li₂FeₓM_{y}P₂O₇, Li₃FeₓM_{y}(PO₄)₃, and LiFeₓM_{y}O₂, and coated on at least one surface of a current collector, where M is at least one or more selected from the group consisting of cobalt (Co), nickel (Ni), manganese (Mn), aluminum (Al), tin (Sn), and antimony (Sb), 0<x≦1, and 0≦y<1, the negative electrode includes one or more negative electrode active materials selected from the group consisting of Li₄(TiₚN_{q})₅O₁₂ and Li₂(TiₚN_{q})₃O₇, and coated on at least one surface of a current collector, where N is at least one or more selected from the group consisting of Co, Ni, Mn, Al, Sn, and Sb, 0<p≦1, and 0≦q<1, and the electrolyte includes a lithium (Li) ion-containing aqueous solution.

The positive electrode active material may be coated with one or more conductive agents selected form the group consisting of Co, Ni, Cu (copper), and cobalt oxide.

The negative electrode active material may be coated with one or more conductive agents selected form the group consisting of Co, Ni, Cu, and cobalt oxide.

The current collector may have a mesh shape.

The current collector may be an Al foil.

The current collector may include a plurality of pores having a diameter of about 0.1 mm to about 0.6 mm formed in a portion, in which the positive electrode active material or the negative electrode active material is formed.

A thickness of the positive electrode may be from about 0.1 mm to about 3.0 mm.

A thickness of the negative electrode is from about 0.1 mm to about 3.0 mm.

The electrolyte may include LiOH.

The electrolyte may further include KOH or NaOH.

The electrolyte may have a LiOH concentration of from about 1 mol/L to about 6 mol/L.

The separator may be a non-woven fabric.

### DETAILED DESCRIPTION

Korean Patent Application No. 10-2012-0025757 filed on Mar. 13, 2012, in the Korean Intellectual Property Office, and entitled: “Lithium Secondary Battery” is incorporated by reference herein in its entirety.

Hereinafter, the present embodiments will be described in more detail.

A lithium secondary battery according to an embodiment includes a positive electrode, a negative electrode, a separator disposed between the positive electrode and the negative electrode, and an electrolyte,

wherein the positive electrode includes one or more positive electrode active materials selected from the group consisting of LiFeₓM_{y}PO₄, Li₂FeₓM_{y}P₂O₇, Li₃FeₓM_{y}(PO₄)₃, and LiFeₓM_{y}O₂, coated on at least one surface of a current collector, where M is at least one or more selected from the group consisting of cobalt (Co), nickel (Ni), manganese (Mn), aluminum (Al), tin (Sn), and antimony (Sb), 0<x≦1, and 0≦y<1,

the negative electrode includes one or more negative electrode active materials selected from the group consisting of Li₄(TiₚN_{q})₅O₁₂ and Li₂(TiₚN_{q})₃O₇, coated on at least one surface of a current collector, where N is at least one or more selected from the group consisting of Co, Ni, Mn, Al, Sn, and Sb, 0<p≦1, and 0≦q<1, and

the electrolyte includes a lithium (Li) ion-containing aqueous solution and the separator is a non-woven fabric.

A positive electrode plate and a negative electrode plate of the lithium secondary battery are prepared by using a LiFePO₄ (LFP) positive electrode active material and a lithium titanate oxide (LTO) negative electrode active material, which are not oxidative-decomposed in water. Also, the lithium secondary battery uses a lithium hydroxide aqueous solution as an electrolyte and thus, may function as a secondary battery without using a typical organic-based electrolyte. Since the lithium secondary battery has more improved stability in comparison to the case that a typical organic electrolyte is used, safety parts may be removed in the secondary battery and as a result, low cost and lightweight may be obtained.

An aqueous-based lithium ion alkaline electrolyte is used in the lithium secondary battery and thus, a thickness of an electrode may be formed to be from 0.1 mm to 3.0 mm. For example, the thickness of the electrode may be from 0.5 mm to 1.5 mm. When compared with a thickness of a typical electrode of about 0.15 mm, the electrode plate is formed to be three times or more thick. Therefore, a volume occupied by the separator and the current collector, which does not affect capacity of the battery, may be reduced while the electrode plate of the lithium secondary battery is made to be thicker. As a result, a lithium secondary battery having high safety and the ability to obtain high energy density may be provided.

The lithium secondary battery uses positive electrode and negative electrode collectors having pores formed therein in order to improve adhesiveness between the electrode collectors and the active materials. A size of the pores may be from 0.1 mm to 0.6 mm. Since the adhesiveness of the active materials may decrease when the size of the pores is 0.1 mm or less, there may be no meaning of using the electrode collectors having the pores formed therein. When the size of the pores is 0.6 mm or more, coating of a slurry may be difficult and uniformity of the electrode may decrease.

When the electrode collectors having no pores formed therein are used, the electrode collectors having a roughness of from about 0.05 mm to about 0.6 mm may be used. When the roughness of the electrode collectors is 0.05 mm or less, battery resistance may increase because adhesiveness with respect to electrode coating portions is poor and detachment is facilitated. When the roughness of the electrode collectors is 0.6 mm or more, coating of a slurry may be difficult and uniformity of the electrode may decrease.

Hereinafter, examples and comparative examples of the present embodiments are described below. However, the following examples are merely presented to exemplify the present embodiments, and the scope of the present embodiments is not limited thereto.

### EXAMPLE 1

### Preparation of Positive Electrode Plate

Li₂CO₃, FeC₂O₄—H₂O, and HN₄H₂PO₄ manufactured by Aldrich were mixed to prepare a pellet form. The mixture having a pellet form was sintered at 600° C. for 24 hours in a nitrogen (N₂) atmosphere to synthesize LiFePO₄. The LiFePO₄ was ground to 1 μm or less by using a ball mill. A positive electrode active material slurry was prepared by mixing 85 wt % of the ground LiFePO₄, 5 wt % of acetylene black (AB, Denka), and 10 wt % of polyvinylidene fluoride (PVDF, Kureha) in a solvent (N-methylpyrrolidone (NMP)). One side of a 15 μm thick aluminum foil was coated with the positive electrode active material slurry. The coated aluminum foil was dried at 100° C. and then pressed. A density of a positive electrode active material coated area pressed in the coated aluminum foil was 1.5 g/cc and a positive electrode plate having a positive electrode active material coating thickness of 150 μm was prepared.

### Preparation of Negative Electrode Plate

TiO₂ and CH₃COOLi manufactured by Aldrich were mixed to prepare a pellet form. The mixture having a pellet form was sintered at 800° C. for 5 hours in an argon atmosphere to synthesize Li₄Ti₅O₁₂. The Li₄Ti₅O₁₂ was ground to 1 μm or less by using a ball mill. A negative electrode active material slurry was prepared by mixing 85 wt % of the ground Li₄Ti₅O₁₂, 5 wt % of AB (Denka), and 10 wt % of PVDF (Kureha) in a solvent (NMP). One side of a 15 μm thick aluminum foil was coated with the negative electrode active material slurry. The coated aluminum foil was dried at 100° C. and then pressed. A density of a negative electrode active material coated area pressed in the coated aluminum foil was 1.5 g/cc and a negative electrode plate having a negative electrode active material coating thickness of 150 μm was prepared.

### Preparation of Electrolyte Including Li Ions

LiOH (Aldrich) was dissolved in a distilled water to prepare a Li ion aqueous-based electrolyte having a concentration of 3 mol/L.

### Preparation of Separator

A 50 μm thick non-woven fabric formed of cellulose was used as a separator. Since the non-woven fabric had a water wetting property and water may thus pass through the non-woven fabric, ionic conductivity and electrical stability of the Li ion aqueous-based electrolyte may be improved.

### Preparation of Electrode Assembly

The separator was disposed between the prepared positive electrode and negative electrode plates, and then wound to prepare an electrode assembly having a jelly-roll shape.

### Preparation of Lithium Secondary Battery

The jelly-roll shaped electrode assembly together with the electrolyte was put in an electrode assembly accommodating part and sealed to complete a lithium secondary battery. The electrode assembly accommodating part may include a cylindrical or prismatic can having an opening formed at one side thereof and a cap plate covering the opening. Also, the electrode assembly accommodating part may have a pouch shape. However, the present embodiments are not limited to the foregoing shapes of the electrode assembly accommodating part.

### EXAMPLE 2

SnO was added to the LiFePO₄ positive electrode active material in Example 1. As a result, LiFe_{0.98}Sn_{0.02}PO₄ including 2% Sn was prepared as a positive electrode active material in Example 2. A lithium secondary battery was prepared in the same manner as Example 1 except that a positive electrode active material in Example 2 was LiFe_{0.98}Sn_{0.02}PO₄.

### EXAMPLE 3

Al was added to the Li₄Ti₅O₁₂ negative electrode active material in Example 1. As a result, Li₄Ti_{4.98}Al_{0.02}O₁₂ including 2% Al was prepared as a negative electrode active material in Example 3. A lithium secondary battery was prepared in the same manner as Example 1 except that a negative electrode active material in Example 3 was Li₄Ti_{4.98}Al_{0.02}O₁₂.

### EXAMPLE 4

The LiFePO₄ positive electrode active material in Example 1 was ground and impregnated with a cobalt hydroxide aqueous solution, and then filtered. Thereafter, the product thus obtained was sintered at 500° C. in a nitrogen (N₂) atmosphere to prepare cobalt hydroxide coated LiFePO₄—CoO. As a result, a lithium secondary battery was prepared in the same manner as Example 1 except that a positive electrode active material in Example 4 was LiFePO₄—CoO.

### EXAMPLE 5

The Li₄Ti₅O₁₂ negative electrode active material in Example 1 was ground and impregnated with a cobalt hydroxide aqueous solution, and then filtered. Thereafter, the product thus obtained was sintered at 500° C. in a nitrogen (N₂) atmosphere to prepare cobalt hydroxide coated Li₄Ti₅O₁₂—CoO. As a result, a lithium secondary battery was prepared in the same manner as Example 1 except that a negative electrode active material in Example 5 was Li₄Ti₅O₁₂—CoO.

### EXAMPLE 6

A lithium secondary battery was prepared in the same manner as Example 1 except that a 25 μm thick aluminum current collector having a plurality of pores with a diameter of 0.5 mm was used instead of a 15 μm thick aluminum current collector having the positive electrode active material and the negative electrode active material coated thereon in Example 1.

### EXAMPLE 7

A lithium secondary battery was prepared in the same manner as Example 1 except that each coating thickness of positive electrode coating portion and negative electrode coating portion was 500 μm.

### EXAMPLE 8

A lithium secondary battery was prepared in the same manner as Example 1 except that 5% of potassium hydroxide was added to an electrolyte.

### EXAMPLE 9

A lithium secondary battery was prepared in the same manner as Example 1 except that a concentration of lithium hydroxide ions in an electrolyte was 5 mol/L.

### EXAMPLE 10

A lithium secondary battery was prepared in the same manner as Example 1 except that a separator material was selected as polyethylene (PE) among polyolefin-based materials and a plasma treatment for sulfonation (—SO₄H) was performed on a surface of the PE. The plasma treatment was performed by ultrasonic irradiation of a sulfuric acid (H₂SO₄) having a concentration of 6M on the polyolefin-based material at 50° C. and the polyolefin-based material was left standing for 1 hour during the plasma treatment. Thereafter, the polyolefin-based material thus prepared was washed with water and dried.

### COMPARATIVE EXAMPLE 1

A lithium secondary battery was prepared in the same manner as Example 1 except that an organic-based electrolyte (1.0 mol/L LiPF₆ in EC/EMC=1:1) was used as an electrolyte.

### COMPARATIVE EXAMPLE 2

A lithium secondary battery was prepared in the same manner as Example 1 except that LiCoO₂ was used as a positive electrode active material.

### COMPARATIVE EXAMPLE 3

A lithium secondary battery was prepared in the same manner as Example 1 except that graphite was used as a negative electrode active material.

### COMPARATIVE EXAMPLE 4

A lithium secondary battery was prepared in the same manner as Example 1 except that a 25 μm thick polyethylene (PE) microporous layer was used as a separator.

### COMPARATIVE EXAMPLE 5

A lithium secondary battery was prepared in the same manner as Example 1 except that each thickness of positive electrode active material and negative electrode active material was 500 μm and an organic-based electrolyte (1.0 mol/L LiPF₆ in EC/EMC=1:1) was used as an electrolyte.

TABLE 1

| | Positive | Negative | | | |
|---|---|---|---|---|---|
| | electrode | electrode | Current | | |
| | active material | active material | collector | Electrolyte | |
| | (thickness) | (thickness) | (thickness) | (concentration) | Separator |
| Example 1 | LiFePO₄ | Li₄Ti₅O₁₂ | Al | LiOH | Non-woven |
| | (150 μm) | (150 μm) | (15 μm) | (3 mol/L) | fabric |
| Example 2 | LiFe_{0.98}Sn_{0.02} | Li₄Ti₅O₁₂ | Al | LiOH | Non-woven |
| | PO₄ (150 μm) | (150 μm) | (15 μm) | (3 mol/L) | fabric |
| Example 3 | LiFePO₄ | Li₄Ti_{4.98}Al_{0.02} | Al | LiOH | Non-woven |
| | (150 μm) | O₁₂ (150 μM) | (15 μm) | (3 mol/L) | fabric |
| Example 4 | LiFePO₄—CoO | Li₄Ti₅O₁₂ | Al | LiOH | Non-woven |
| | (150 μm) | (150 μm) | (15 μm) | (3 mol/L) | fabric |
| Example 5 | LiFePO₄ | Li₄Ti₅O₁₂—CoO | Al | LiOH | Non-woven |
| | (150 μm) | (150 μm) | (15 μm) | (3 mol/L) | fabric |
| Example 6 | LiFePO₄ | Li₄Ti₅O₁₂ | Al | LiOH | Non-woven |
| | (150 μm) | (150 μm) | (25 μm) | (3 mol/L) | fabric |
| Example 7 | LiFePO₄ | Li₄Ti₅O₁₂ | Al | LiOH | Non-woven |
| | (500 μm) | (500 μm) | (15 μm) | (3 mol/L) | fabric |
| Example 8 | LiFePO₄ | Li₄Ti₅O₁₂ | Al | LiOH + KOH | Non-woven |
| | (150 μm) | (150 μm) | (15 μm) | (3 mol/L) | fabric |
| Example 9 | LiFePO₄ | Li₄Ti₅O₁₂ | Al | LiOH | Non-woven |
| | (150 μm) | (150 μm) | (15 μm) | (5 mol/L) | fabric |
| Example 10 | LiFePO₄ | Li₄Ti₅O₁₂ | Al | LiOH | PE(—SO₄H) |
| | (150 μm) | (150 μm) | (15 μm) | (3 mol/L) | |
| Comparative | LiFePO₄ | Li₄Ti₅O₁₂ | Al | LiPF₆ | Non-woven |
| Example 1 | (150 μm) | (150 μm) | (15 μm) | (1 mol/L) | fabric |
| Comparative | LiCoO₂ | Li₄Ti₅O₁₂ | Al | LiOH | Non-woven |
| Example 2 | (150 μm) | (150 μm) | (15 μm) | (3 mol/L) | fabric |
| Comparative | LiFePO₄ | Graphite | Al | LiOH | Non-woven |
| Example 3 | (150 μm) | (150 μm) | (15 μm) | (3 mol/L) | fabric |
| Comparative | LiFePO₄ | Li₄Ti₅O₁₂ | Al | LiOH | PE |
| Example 4 | (150 μm) | (150 μm) | (15 μm) | (3 mol/L) | |
| Comparative | LiFePO₄ | Li₄Ti₅O₁₂ | Al | LiPF₆ | Non-woven |
| Example 5 | (500 μm) | (500 μm) | (15 μm) | (1 mol/L) | fabric |

The following Table 2 is the test results of battery characteristics of Examples 1 to 9 and Comparative Examples 1 to 5.

### Method of Testing Battery Characteristics of Lithium Secondary Battery

The lithium secondary battery was charged at a constant current of 200 mA and the charge was terminated at a voltage of the lithium secondary battery of 2.5 V. The charged lithium secondary battery was discharged at a constant current of 200 mA and the discharge was terminated at a voltage of the lithium secondary battery of 1.5 V. An initial capacity of the lithium secondary battery was determined at this time.

Also, the lithium secondary battery was charged at a constant current of 200 mA and the charge was terminated at a voltage of the lithium secondary battery of 2.5 V. Capacity of the battery was measured when the charged lithium secondary battery was discharged at a current of 400 mA until the voltage reached 1.5 V. The measured results were determined as high-rate discharge characteristics.

The lithium secondary battery was charged at a current of 4000 mA until the voltage reached 2.5 V and discharged at a current of 4000 mA until the voltage reached 1.5 V, and the foregoing charge and discharge cycle was repeated 1000 times. After 1000 cycles of charge and discharge, a residual capacity (%) with respect to the initial capacity of the lithium secondary battery was measured.

Further, the lithium secondary battery was charged at a constant current of 200 mA and the charge was terminated at a battery voltage of 2.5 V. Thereafter, the battery in a charged state was put in a constant temperature bath and the temperature thereof was increased to 300° C. at a heating rate of 5° C./min while a surface temperature of the battery was measured. Thermal safety was measured while checking unexpected heat generation until the temperature of the constant temperature bath reached 300° C.

TABLE 2

| | | | | 1000 cycle | |
|---|---|---|---|---|---|
| | | | Discharge | residual | |
| | Initial capacity | | power | capacity % | Thermal safety |
| Example 1 | 1012 | mAh | 82% | 75% | ∘ |
| Example 2 | 995 | mAh | 86% | 78% | ∘ |
| Example 3 | 1005 | mAh | 85% | 78% | ∘ |
| Example 4 | 992 | mAh | 89% | 85% | ∘ |
| Example 5 | 1003 | mAh | 88% | 83% | ∘ |
| Example 6 | 1082 | mAh | 86% | 82% | ∘ |
| Example 7 | 1250 | mAh | 80% | 73% | ∘ |
| Example 8 | 1015 | mAh | 85% | 78% | ∘ |
| Example 9 | 1018 | mAh | 89% | 82% | ∘ |
| Example 10 | 1021 | mAh | 81% | 80% | ∘ |
| Comparative | 982 | mAh | 65% | 55% | x |
| Example 1 | | | | | |
| Comparative | Battery function: No Good (NG) | | | | |
| Example 2 | | | | | |
| Comparative | Battery function: NG | | | | |
| Example 3 | | | | | |
| Comparative | Battery function: NG | | | | |
| Example 4 | | | | | |
| Comparative | 750 | mAh | 32% | 15% | x |

Example 5

Initial capacities of the batteries in Examples 1 to 10 were from 982 mAh to 1250 mAh and it was confirmed that the initial capacities of the batteries in Examples 1 to 10 were higher than those of the batteries in Comparative Examples, i.e., a range of 750 mAh to 982 mAh. Also, an aqueous-based Li ion electrolyte was used in Example 1, and since the initial capacity of Example 1 was higher than that of Comparative Example 1 using an organic-based electrolyte and thermal safety was maintained to improve stability of the battery, safety parts may be removed in the secondary battery.

LiFe_{0.98}Sn_{0.02}PO₄ containing 2% Sn was used as a positive electrode active material in Example 2. Li₄Ti_{4.98}Al_{0.02}O₁₂ containing 2% Al was used as a negative electrode active material in Example 3. When Examples 2 and 3 were compared with Example 1, it may be understood that discharge powers and residual capacities (%) were improved. Also, the same positive electrode active material as Example 1 was coated with cobalt oxide (CoO) in Example 4, and the same negative electrode active material as Example 1 was coated with cobalt oxide (CoO) in Example 5. Therefore, it may be understood that discharge power and residual capacity (%) were most superior when the positive electrode active material or the negative electrode active material were coated with CoO. It may be understood that the CoO functioned as a conductive agent. Therefore, the lithium secondary battery according to the present embodiments may have high input and output performance.

Further, it may be understood that initial capacity, discharge power, residual capacity (%), and thermal safety of the battery in Example 6 were improved while the electrode plate not affecting the capacity of the battery was made to be thick.

In Example 7, the electrode coating portions affecting the capacity of the battery were formed to be thicker than those of Example 1. As a result, the initial capacity of the battery in Example 7 was the highest. It may be understood that even in the case that the electrode coating portions was formed to be thick, initial capacity, discharge power, and residual capacity (%) may decrease and thermal safety may not improved when the organic-based electrolyte was used (Comparative Example 5).

Potassium hydroxide was added to the electrolyte in Example 8. When compared with Example 1, in which potassium hydroxide was not added, it may be understood that initial capacity, discharge power, residual capacity (%), and thermal safety of the battery were improved. As a result, it may be understood that since potassium hydroxide was added in Example 8, the ionic conductivity thereof was improved in comparison to that of Example 1.

When Example 9 was compared with Example 1, it may be understood that the higher the concentration of the electrolyte was, the more improved the initial capacity, discharge power, and residual capacity (%) of the battery were.

Since the PE separator was surface treated by sulfonation (—SO₄H) in Example 10, it may be understood that initial capacity, discharge power, and residual capacity (%) of the battery were improved because the water wetting property of the PE separator was improved in comparison to that of the separator in Comparative Example 4.

It may be understood that the battery did not function in the battery characteristic test when lithium cobalt oxide (LiCoO₂) was used as a positive electrode active material instead of an olivine-based active material (Comparative Example 2). It may also be understood that the battery did not function in the battery characteristic test when Graphite was used as a negative electrode active material (Comparative Example 3). Further, it may be understood that the battery did not function in the battery characteristic test when a PE material without surface treatment was used as a separator (Comparative Example 4).

According to the present embodiments, thermal safety was maintained because an aqueous-based Li ion electrolyte was used. Therefore, parts of safety measures may be mostly removed in the lithium secondary battery of the present embodiments.

Also, since the electrode coating portions affecting the capacity of the battery may be formed to be thick in the lithium secondary battery of the present embodiments, high voltage and high capacity may be obtained.

The lithium secondary battery according to an embodiment has stable characteristics at an average voltage of 2 V and may be used without deteriorating in a high-temperature environment. Also, charge characteristics in a low-temperature environment are better than those of a typical lithium ion battery.

A Li ion-containing aqueous solution is used in the lithium secondary battery according to the embodiment and thus, density of the electrode may be high in comparison to the case that an organic-based electrolyte is used. Since the electrode may be formed to be thick, high energy density may be obtained.

Also, since the lithium secondary battery according to the embodiment has high ionic conductivity, high input and output performance may be possible.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims.

What is claimed is:

1. A lithium secondary battery comprising:
a positive electrode;
a negative electrode;
a separator disposed between the positive electrode and the negative electrode; and
an electrolyte,
wherein the positive electrode comprises one or more positive electrode active materials selected from the group consisting of LiFeₓM_{y}PO₄, Li₂FeₓM_{y}P₂O₇, Li₃FeₓM_{y}(PO₄)₃, and LiFeₓM_{y}O₂, coated on at least one surface of a current collector, where M is at least one or more selected from the group consisting of Co, Ni, Mn, Al, Sn, and Sb,
0<x≦1,
0≦y<1,
wherein the negative electrode comprises one or more negative electrode active materials selected from the group consisting of Li₄(TiₚN_{q})₅O₁₂ and Li₂(TiₚN_{q})₃O₇, coated on at least one surface of a current collector, where N is at least one or more selected from the group consisting of Co, Ni, Mn, Al, Sn, and Sb,
0<p≦1,
0≦q<1, and
the electrolyte comprises a Li ion-containing aqueous solution.

2. The lithium secondary battery as claimed in claim 1, wherein the positive electrode active material is coated with one or more conductive agents selected form the group consisting of Co, Ni, Cu, and cobalt oxide.

3. The lithium secondary battery as claimed in claim 1, wherein the negative electrode active material is coated with one or more conductive agents selected form the group consisting of Co, Ni, Cu, and cobalt oxide.

4. The lithium secondary battery as claimed in claim 1, wherein the current collector has a mesh shape.

5. The lithium secondary battery as claimed in claim 1, wherein the current collector is Al.

6. The lithium secondary battery as claimed in claim 4, wherein the current collector comprises a plurality of pores having a diameter of about 0.1 mm to about 0.6 mm formed in a portion, in which the positive electrode active material or the negative electrode active material is formed.

7. The lithium secondary battery as claimed in claim 1, wherein a thickness of the positive electrode is from about 0.1 mm to about 3.0 mm.

8. The lithium secondary battery as claimed in claim 1, wherein a thickness of the negative electrode is from about 0.1 mm to about 3.0 mm.

9. The lithium secondary battery as claimed in claim 1, wherein the electrolyte comprises LiOH.

10. The lithium secondary battery as claimed in claim 9, wherein the electrolyte further comprises KOH or NaOH.

11. The lithium secondary battery as claimed in claim 1, wherein the electrolyte has a LiOH concentration of from about 1 mol/L to about 6 mol/L.

12. The lithium secondary battery as claimed in claim 1, wherein the separator is a non-woven fabric.

13. The lithium secondary battery as claimed in claim 1, wherein the current collector has a roughness of from about 0.05 mm to about 0.6 mm.

14. The lithium secondary battery as claimed in claim 1, wherein the separator is a polyolefin-based material surface treated by one selected from the group consisting of a plasma treatment, a corona discharge treatment, a sulfonation treatment, and an acrylic acid craft treatment.

15. The lithium secondary battery as claimed in claim 1, wherein the positive electrode comprises LiFePO₄.

16. The lithium secondary battery as claimed in claim 1, wherein the negative electrode comprises Li₄Ti₅O₁₂.

17. The lithium secondary battery as claimed in claim 1, wherein the positive electrode comprises LiFePO₄—CoO.

18. The lithium secondary battery as claimed in claim 1, wherein the negative electrode comprises Li₄Ti₅O₁₂—CoO.

19. The lithium secondary battery as claimed in claim 1, wherein the positive electrode comprises LiFe_{0.98}Sn_{0.02}PO₄.

20. The lithium secondary battery as claimed in claim 1, wherein the negative electrode comprises Li₄Ti_{4.98}Al_{0.02}O₁₂.
